(19) United States
(12) Patent Application Publication
(10) Pub. No.: US 2006/0262281 A1
(43) Pub. Date: Nov. 23, 2006

(54) Low profile mirror adjustment system for rear projection display

(76) Inventor: Scott Joseph Duggan, Indianapolis, IN (US)

Correspondence Address: THOMSON LICENSING INC., PATENT OPERATIONS, PO BOX 5312, PRINCETON, NJ, 08543-5312, US

(21) Appl. No.: 10/567,721

(22) PCT Filed: Aug. 10, 2004
(86) PCT No.: PCT/US04/25898

§ 371 Date: Feb. 8, 2006

Related U.S. Application Data
(60) Provisional application No. 60/498,257, filed on Aug. 26, 2003.

(51) Int. Cl. G03B 21/28; G03B 21/22

(52) U.S. Cl. 353/77; 353/98

(57) ABSTRACT

A low profile mirror adjustment system for a rear projection display is described. The mirror adjustment system includes one or more adjuster screws and one or more spring clips. The adjuster screw and the spring clip work in unison with a support bracket to permit small adjustments for the mirror angle, if needed.

### CROSS-REFERENCE TO RELATED APPLICATIONS

This application claims the benefit of U.S. Provisional Patent Application Ser. No. 60/498,257, entitled “Low Profile Mirror Adjustment System For Rear Projection Display” and filed Aug. 26, 2003, which is incorporated by reference herein in its entirety.

### FIELD OF THE INVENTION

The present invention is directed toward displays and in particular, toward rear projection displays.

### BACKGROUND OF THE INVENTION

Most rear projection displays include a mirror mounted inside the rear of the display. The mirror alignment is critical to projection display performance. Typically, small adjustments are made to the mirror angles to provide good mirror alignment.

One technique for making mirror adjustments uses a gimbal mechanism that allows independent adjustment of the mirror about multiple axes. However, such gimbal mechanisms are expensive and once adjusted have difficulty maintaining the set location.

Another technique for making mirror adjustments uses independent screws with locknuts on each side of the mirror. The locknuts function to keep the adjustments from changing once set. Unfortunately, this adjustment process is time consuming and difficult for the factory to implement.

Still another technique for making mirror adjustments uses shims. However, it is difficult to predict this adjustment process since the shim is placed after the mirror is seated. Also, the resolution of the adjustment is only as good as the thinness of the shims being used.

Therefore, an inexpensive mirror adjustment mechanism is needed for a rear projection display.

### SUMMARY OF THE INVENTION

The present invention is a low profile mirror adjustment system for a rear projection display. The mirror adjustment system includes one or more adjuster screws and one or more spring clips. The adjuster screw and the spring clip work in unison with a support bracket to permit small adjustments to the mirror angle, if needed.

### BRIEF DESCRIPTION OF THE DRAWINGS

The invention is hereinafter described in detail with reference to the accompanying drawings, in which:

FIG. 1 depicts a side view of a projection display;

FIG. 2 depicts a side view of one embodiment of the low profile mirror adjustment system of the present invention; and

FIG. 3 depicts an assembled side view of the low profile mirror adjustment system shown in FIG. 1.

### DETAILED DESCRIPTION

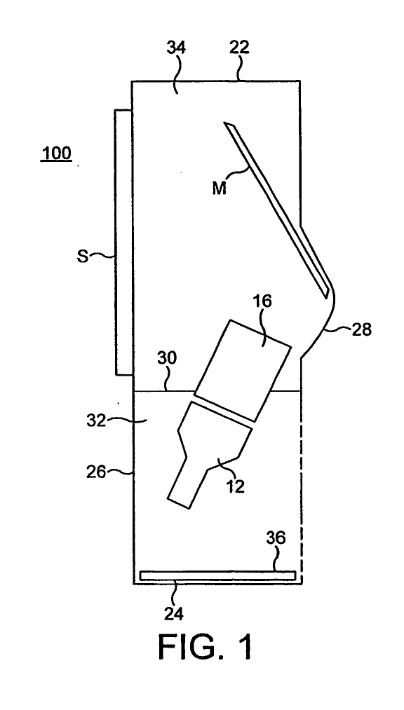

Referring to FIG. 1, a rear projection display 100 includes a top 22, bottom 24, front 26 and rear 28, and is divided by an internal wall 30 into two compartments, i.e., upper 34 and lower 32 compartments. The light engine 12, projection lenses 16 and printed wiring boards (PWBS) 36 are mounted in the lower compartment 32, while the mirror M and screen S are mounted in the upper compartment 34. The upper compartment 34 is typically sealed from the lower compartment 32 to protect the inside of the upper compartment 34 from dust and other foreign materials.

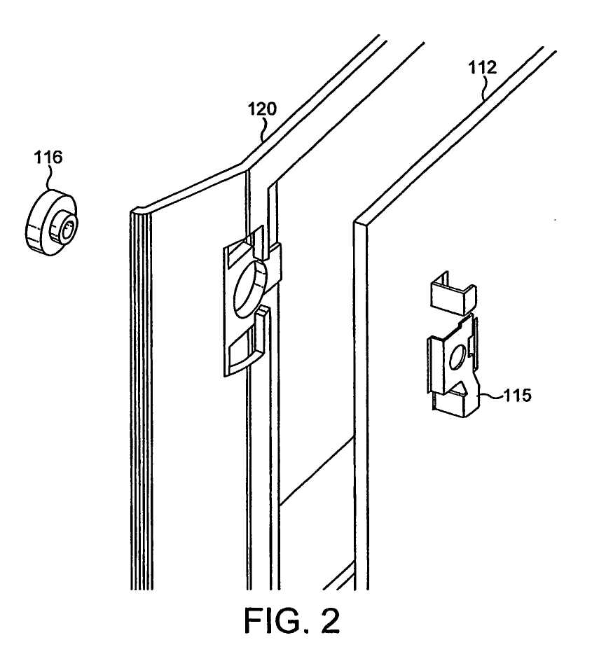

The present invention is a low profile mirror adjustment system 110 for the mirror M of the rear projection display 100. The mirror adjustment system 110 is shown in FIG. 2 and includes one or more adjuster screws 116 and one or more spring clips 115. The adjuster screws 116 and the spring clips 115 work in unison with a support bracket 120 to permit small adjustments to the mirror 112 angle, if needed.

The spring clips 115 should be formed of a metal, such as for example spring steel), or plastic. The adjuster screws 116 may be form of a metal or plastic and may be made using any suitable process such as for example sheet metal forming, roll forming, and die casting, among others.

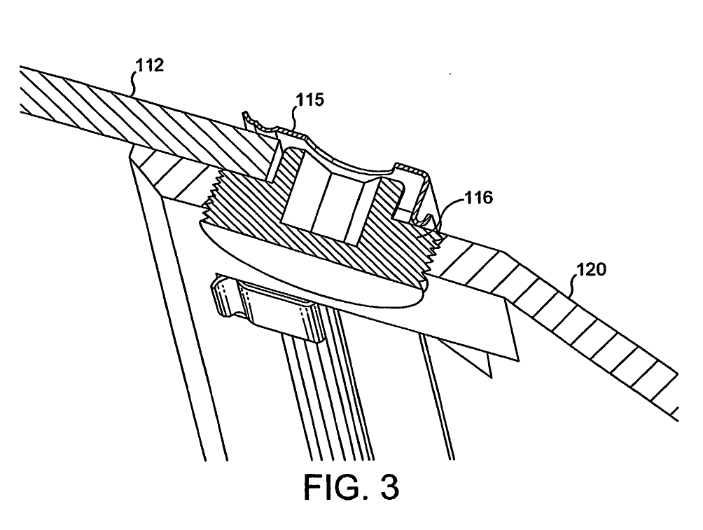

Referring to FIGS. 2 and 3, three adjuster screws 116 and spring clips 115 may work in unison with a mirror support bracket 120 to permit small adjustments to the mirror 112 angle. The spring clips 115 are affixed to the back of the mirror 112 and are used to attach the mirror 112 directly on the support bracket 120. Each spring clip 115 is affixed to the mirror 112 over a corresponding adjuster screw 116 location on the support bracket 120. The adjuster screw 116 has a detail portion that seats to the support bracket 120, preventing movement after the adjuster screw has been set. When adjusted the adjuster screw 116 moves both the mirror 112 and the spring clip 115 relative to the support bracket 120. The forces generated by the spring clips 115 on the mirror 112 are located such that small bending moments are imparted on the mirror 112 when the adjuster screws 116 are moved. As such, the mirror remains securely fastened to the support bracket 120.

The foregoing illustrates some of the possibilities for practicing the invention. Many other embodiments are possible within the scope and spirit of the invention. It is, therefore, intended that the foregoing description be regarded as illustrative rather than limiting, and that the scope of the invention is given by the appended claims together with their full range of equivalents.

What is claimed is:

1. A mirror adjustment system for a rear projection display, comprising:
a mirror;
one or more adjuster screws for attaching the mirror to a mirror support bracket; and
one or more spring clips affixed to the mirror, wherein the one or more adjuster screws and the one or more spring clips work in unison to adjust an angle for the mirror relative to the mirror support bracket.

2. The mirror adjustment system of claim 1 wherein the one or more adjuster screws are formed of a material selected from the group consisting of metal and plastic.

3. The mirror adjustment system of claim 1 wherein the one or more spring clips are formed of a material selected from the group consisting of metal and plastic.

4. The mirror adjustment system of claim 3 wherein the one or more spring clips are formed of spring steel.

5. A projection display including a mirror adjustment system, comprising:
a mirror;
one or more adjuster screws for attaching the mirror to a mirror support bracket; and
one or more spring clips affixed to the mirror, wherein the one or more adjuster screws and the one or more spring clips work in unison to adjust an angle for the mirror relative to the mirror support bracket.

6. The projection display of claim 5 wherein the one or more adjuster screws are formed of a material selected from the group consisting of metal and plastic.

7. The projection display of claim 5 wherein the one or more spring clips are formed of a material selected from the group consisting of metal and plastic.

8. The projection display of claim 7 wherein the one or more spring clips are formed of spring steel.
